(19) United States
(12) Patent Application Publication
(10) Pub. No.: US 2018/0091609 A1
(43) Pub. Date: Mar. 29, 2018

(54) FOLLOWING METRICS FOR A/B TESTING

(71) Applicant: LinkedIn Corporation, Mountain View, CA (US)

(72) Inventors: Ya Xu, Los Altos, CA (US); Kylan Matthew Nieh, Fremont, CA (US); Weitao Duan, Mountain View, CA (US); Bo Liu, Mountain View, CA (US); Luisa Fernanda Hurtado Jaramillo, Sunnyvale, CA (US); Jessica Reel, Pacifica, CA (US); Bryan Tai An Chen, San Jose, CA (US)

(21) Appl. No.: 15/279,280

(22) Filed: Sep. 28, 2016

(51) Int. Cl. H04L 29/08; H04L 12/58

(52) U.S. Cl. CPC H04L 67/22; G06Q 50/01; H04L 51/32; H04L 67/306

(57) ABSTRACT

A machine may be configured to facilitate following metrics generated by an A/B testing system. For example, the machine determines, based on a metric identifier of a metric that measures an aspect of a service provided on a Social Networking Service, one or more experiment identifiers of experiments that impact the metric. The machine accesses, based on the metric identifier, a subscription record in a database. The subscription record identifies one or more users who requested to follow the particular metric. The machine identifies, based on the subscription record, a user identifier of a user who requested to follow the metric. The machine generates a digital content item that references the metric and the experiments that impact the metric. The machine causes a presentation of the digital content item in a user interface of a client device associated with the user.

### TECHNICAL FIELD

The present application relates generally to systems, methods, and computer program products for facilitating following metrics generated by an A/B testing system.

### BACKGROUND

Many companies that deliver online digital content or services utilize experiments to test the performance of the online digital content or services. A/B testing may be used to perform an experiment pertaining to delivery of content online, and to determine which variant of two variants of the experiment better accomplishes a particular goal of the experiment. Usually, in A/B testing, a group of online users is divided into a treatment group to receive the treatment variant of the experiment, and a control group to receive the control variant of the experiment. Based on the user responses received from the members of the treatment group and the control group, a conclusion regarding the goal of the experiment may be drawn.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a block diagram illustrating components of a metrics following system, according to some example embodiments;

FIG. 3 is a diagram illustrating an example user interface for displaying followed metrics, according to some example embodiments;

FIG. 4 is a flowchart illustrating a method for facilitating following metrics generated by an A/B testing system, according to sonic example embodiments;

FIG. 5 is a flowchart illustrating a method for facilitating following metrics generated by an A/B testing system, and representing additional steps of the method illustrated in FIG. 4, according to some example embodiments;

FIG. 6 is a flowchart illustrating a method for facilitating following metrics generated by an A/B testing system, and representing additional steps of the method illustrated in FIG. 4, according to some example embodiments;

FIG. 7 is a flowchart illustrating a method for facilitating following metrics generated by an A/B testing system, and representing additional steps of the method illustrated in FIG. 4 and step 408 of the method illustrated in FIG. 4 in more detail, according to some example embodiments;

FIG. 8 is a flowchart illustrating a method for facilitating following metrics generated by an A/B testing system, and representing additional steps of the method illustrated in FIG. 4, according to some example embodiments;

FIG. 9 is a block diagram illustrating a mobile device, according to some example embodiments; and

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems for facilitating following metrics generated by an A/B testing system are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may he combined or subdivided, and operations may vary in sequence or be combined or subdivided.

Traditionally, A/B testing has been used for testing digital content delivered online. When using A/B testing, a first group of online users may be assigned to a treatment group to receive a treatment variant of an experiment (hereinafter also “test”), and a second group of online users may be assigned to a control group to receive a control variant of the experiment. For example, different users may be assigned to different variants and, therefore, may receive different variants of a digital content item (e.g., a member profile). The assignment of a user to a particular variant may be based, for instance, on a browser identifier previously determined using a request for the member profile received from the client device of the user. The users may be members of a social networking service (hereinafter also “SNS”), such as LinkedIn®.

An A/B testing system may facilitate the definition of a segment of users to be targeted in an experiment, and the definition of different variants for the experiment. The variants of the experiments may he defined by uploading files, images, HTML code, webpages, data, etc., associated with each variant and by providing a name for each variant. One of the variants may correspond to an existing feature or variant, also referred to as a “control” variant, while one or more other variants (also referred to as “treatment” variants) may correspond to a new feature being tested. For example, if the A/B experiment is testing a user response (e.g., click through rate or CTR) for a button on a homepage of an online SNS, the different variants may correspond to different types of buttons such as a blue circle button, a blue square button with rounded corners, and so on. To define the different variants, an administrator may upload image files of the appropriate buttons and/or code (e.g., HTML code) associated with different versions of the webpage containing the different variants.

The execution of an A/B test includes the applying of the different variants of the A/B test to the different groups of users assigned to the different variants. In some instances, the applying of different variants of the A/B test to the different groups of users includes providing digital content items to the client devices of the users that are different in a particular respect, and tracking user responses with respect to the difference between the digital content items. As a result of applying the different A/B test variants to different groups of users, the A/B testing system collects data that pertains to the users of the different groups interacting with the digital content associated with the different variants of the A/B test. The collected data may include the A/B test results. The A/B testing system (or a different system) may process the A/B test results and may generate metrics that measure various aspects of the service or of the digital content provided during the execution of the A/B test.

Traditionally, people involved in data-driven decision making spend numerous hours analyzing experiment result data to determine which variant of several variants of an experiment better accomplishes a particular goal of the experiment. In some instances, the analyzing of the experiment result data may involve trying to determine which metric better facilitates an understanding of the experiment result data. This may be a very time-consuming activity. As more experiment result data is generated and as more metrics are created, the tasks of understanding the experiment results and of making data-driven decisions become more and more difficult.

It may be beneficial to online digital content creators to implement a metrics following system that facilitates the “following” of the metrics generated by the A/B testing system. The metrics following system simplifies and increases the efficiency of the data search processes performed by one or more machines of the A/B testing system. The A/B testing system may be internal or external to the metrics following system.

The “following” of a particular metric may include the ability to access or receive information pertaining to the particular metric including information pertaining to factors that impact the particular metric, such as various experiments that positively or negatively affect the particular metric. A user may subscribe to follow one or more metrics of interest to the user. For example, a user requests to subscribe to follow a metric. The request may be generated via a user interface caused, by the metrics following system, to display in a user interface of a client device associated with the user. The metrics following system may identify the metrics followed by the user and may generate a customized digital content item for the user that includes data pertaining to the metrics followed by the user and the experiments that impact those metrics. By following certain metrics, the user may receive alerts based on various factors, such as an experiment ramp-up that exceeds a certain ramp percentage value, a site-wide impact of the experiment on the metric that exceeds a certain threshold value, etc. The alerts may identify the metrics (e.g., provide the names of the metrics) followed by the user, and may notify the user of the names of the experiments that impact the metric, and the names of the owners of the respective experiments. Each metric followed by the user may be displayed in association with a tag that identifies the type of tier of the metric. Accordingly, the metrics following system generates a customized digital content item for each user based on the metrics following requests received from each user.

The metric follower (e.g., the user), based on the customized digital content item displayed in an alert or in a dashboard, may take a number of actions, such as sending a message to the test owner from the user interface displaying the customized digital content item, unfollowing the metric, etc. The metric follower may also request additional information, for example, by clicking on the identifier of a test that impacts the metric. Based on the selection of the identifier of the test, the metrics following system may expand the amount of data pertaining to the test that is presented to the user. For instance, the metrics following system accesses from a record in a database, and displays identifiers and descriptions of various variants of the test.

The metrics following system may also illustrate how each test, or each variant of each test, impacts a particular metric: negatively or positively, and to what degree. The metrics following system may also facilitate the toggling between specific dates or time ranges associated with different tests to see how much the metric was affected at different times. In some instances, the different time periods may correspond to different ramp percentages of the test.

According to some example embodiments, the metrics following system determines one or more experiment identifiers of the experiments that impact a particular metric. The metric measures an aspect of a service provided on the SNS. The determining of the one or more experiment identifiers may be based on a metric identifier of the particular. The metrics following system accesses, based on the metric identifier of the particular metric, a subscription record in a database. The subscription record may identify one or more users who requested to follow the particular metric. The metrics following system identifies, based on the subscription record, a user identifier of a user of the one or more users who requested to follow the particular metric. The metrics following system generates a digital content item that references the particular metric and the experiments that impact the particular metric. The generating of the digital content item may be based on the one or more experiment identifiers of experiments that impact the particular metric and based on the user identifier of the user. The metrics following system causes a presentation of the digital content item in a user interface of a client device associated with the user.

In some example embodiments, the metrics following system facilitates the generation of a user's subscription to follow the particular metric. For example, a user, using his login credentials, logs into an application that allows users to subscribe to follow metrics. The application may identify the user's credentials based on the request to log in. The metrics following system may cause a presentation of a further user interface on the client device. The further user interface may include one or more selectable elements pertaining to requesting a following of one or more metrics. The user may select a selectable element, such as a “follow” button, that is displayed to indicate an association with an identifier of the particular metric. The metrics following system receives a communication that indicates the selection of the selectable element from the client device. The selection of the selectable element corresponds to a request by the user to follow the particular metric.

The metrics following system determines, based on the receiving of the selection of the selectable element, that the selectable element selected by the user corresponds to the particular metric. The metrics following system associates the user identifier with a metric identifier based on the receiving of the selection of the selectable element. In some example embodiments, the associating of the user identifier with the metric identifier includes adding the user identifier to the subscription record that identifies the one or more users who requested to follow the particular metric. For example, the metrics following system adds a row to a record that includes user identifies of the users who subscribed to follow the particular metric. Alternately, or in addition, the metric identifier is added to a record that includes metric identifiers of the metrics that the particular user subscribed to follow. The record may be associated with a user identifier of the user.

In some example embodiments, once a user has subscribed to follow a metric, the user may access a metrics following dashboard (e.g., a user interface) to view the metrics that the user subscribed to follow. Alternately or additionally, the user may receive notifications pertaining to the followed metrics via various communication channels (e.g., email, phone, etc.). The notifications may be scheduled communications that are delivered at certain times (e.g., once a day, several time a week, etc.), or may be alerts that are triggered by certain events. For instance, an alert associated with a metric ABC may be issued by the metrics following system when an experiment that impacts the metric ABC has been ramped up above a certain threshold ramp percentage value. The alert may be communicated by the metrics following system to the users who subscribed to follow the metric ABC. In some instances, a digital content item pertaining to one or more metrics followed by a user may be generated by the metrics following system on demand.

The implementation of the metrics following system has many benefits. The automatic generation of digital content items that are customized based on at least the metrics following requests received from the users allows for a significant scaling up of the amount of experiment and metrics data that can be analyzed, and for an efficient use (e.g., re-use) of analysis results in the generation of the customized digital content items. The metrics following system may automatically notify the metrics followers about the events that impact the followed metrics without direct or continuous user involvement.

According to some example embodiments, one or more of the methodologies discussed herein may obviate a need for additional searching for information (e.g., metrics data searches, experiment result searches, etc.), which may have the technical effect of reducing computing resources used by one or more devices within the metrics following system, or within systems or databases associated with the metrics following system. Examples of such computing resources include, without limitation, processor cycles, network traffic, memory usage, storage space, and power consumption.

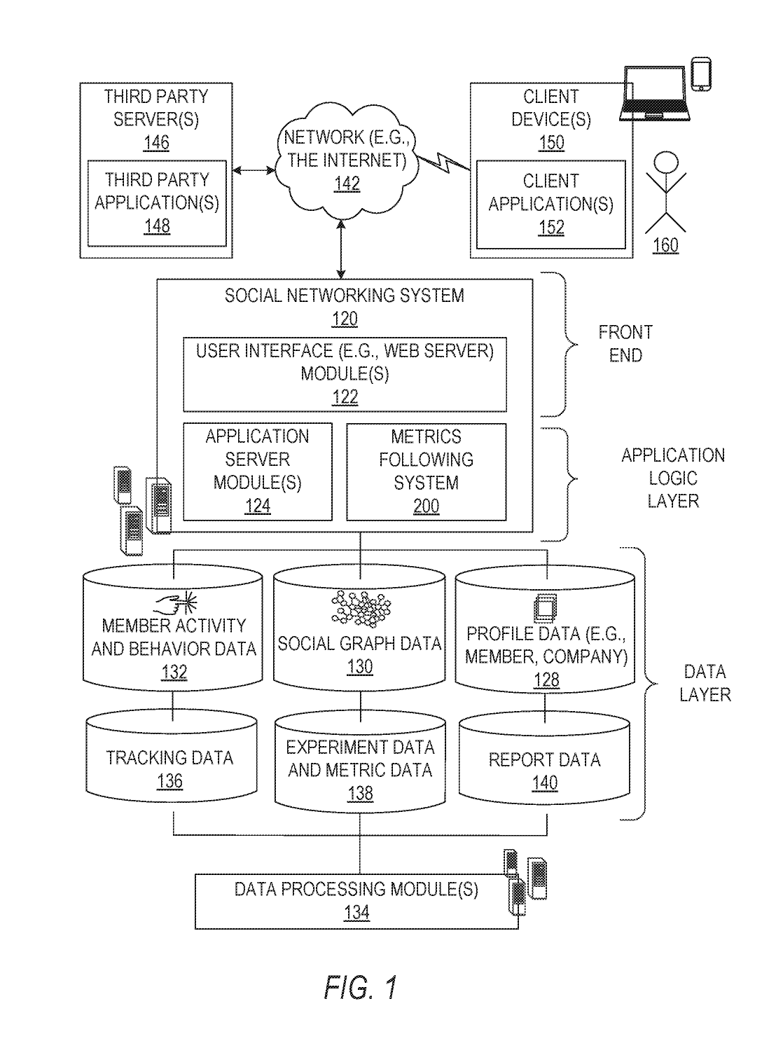

An example method and system for facilitating following metrics generated by an A/B testing system may be implemented in the context of the client-server system illustrated in FIG. 1. As illustrated in FIG. 1, the metrics following system 200 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 142 to exchange information with the social networking system 120. Each of the client devices 150 may comprise a computing device that includes at least a display and communication capabilities with the network 142 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., digital content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, a metric, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available digital content items for presentation to the member in his or her content stream increases. As members interact with various applications, content, and user interfaces of the social networking system 120, information relating to the member's activity and behavior may be stored in a database, such as the database 132. An example of such activity and behavior data is the identifier of an online ad consumption event associated with the member (e.g., an online ad viewed by the member), the date and time when the online ad event took place, an identifier of the creative associated with the online ad consumption event, a campaign identifier of an ad campaign associated with the identifier of the creative, etc. Another example of such activity and behavior data is a request, received from a client device of the member, to follow a metric generated in an A/B testing environment as a result of executing one or more A/B experiments.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the SNS may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some example embodiments, members may receive digital communications (e.g., advertising, news, status updates, metric following content, etc.) targeted to them or customized for them based on various factors (e.g., member profile data, social graph data, member activity or behavior data, subscription requests, following requests, etc.)

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For example, an ad serving engine showing ads to users may be implemented with one or more application server modules 124. According to another example, a messaging application, such as an email application, an instant messaging application, or some hybrid or variation of the two, may be implemented with one or more application server modules 124. A photo sharing application may be implemented with one or more application server modules 124. Similarly, in some instances, a search engine enabling users to search for and browse member profiles, experiment data, or metrics data may be implemented with one or more application server modules 124. Of course, other applications and services may be separately embodied in their own application server modules 124. As illustrated in FIG. 1, social networking system 120 may include the metrics following system 200, which is described in more detail below.

Further, as shown in FIG. 1, a data processing module 134 may be used with a variety of applications, services, and features of the social networking system 120. The data processing module 134 may periodically access one or more of the databases 128, 130, 132, 136, 138, or 140, process (e.g., execute batch process jobs to analyze or mine) profile data, social graph data, member activity and behavior data, tracking data, experiment data, metric data, or report data, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

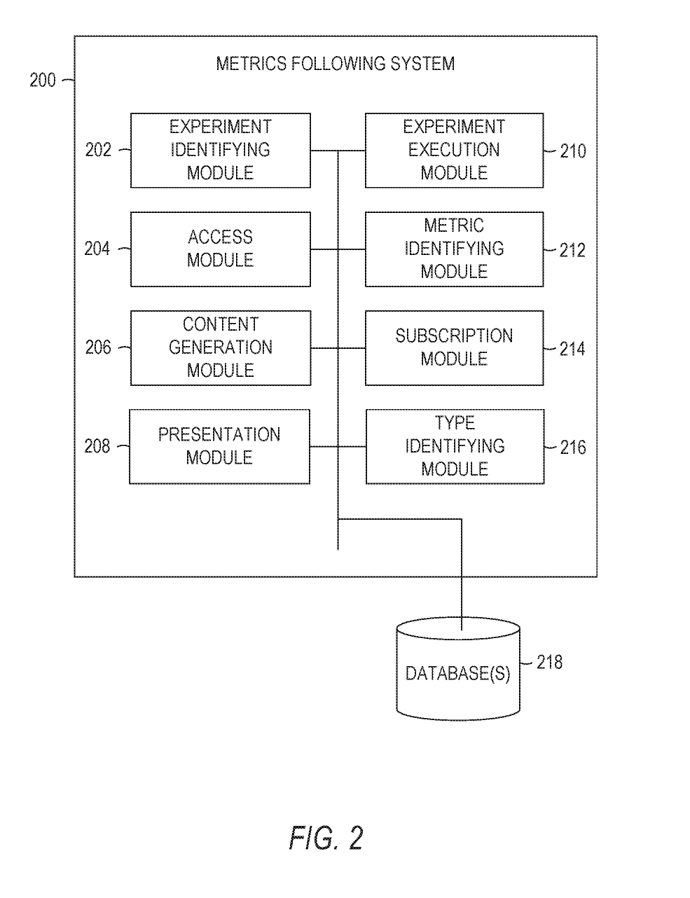

FIG. 2 is a block diagram illustrating components of the metrics following system 200, according to some example embodiments. As shown in FIG. 2, the metrics following system 200 includes an experiment identifying module 202, an access module 204, a content generation module 206, a presentation module 208, an experiment execution module 210, a metric identifying module 212, a subscription module 214, and a type identifying module 216, all configured to communicate with each other (e.g., via a bus, shared memory, or a switch).

According to some example embodiments, the experiment identifying module 202 identifies, or otherwise determines, one or more experiment identifiers of experiments that impact a particular metric that measures an aspect of a service provided on a Social Networking Service (SNS). The determining of the one or more experiment identifiers of experiments that impact a particular metric may be based on a metric identifier (e.g., a name) of the particular metric. The metric identifier may be obtained, for example, via user input, An example service provided on the SNS is an automatic delivery of a type of email messages to members of the SNS, and an example aspect of the service that is measured by the particular metric is the number of requests to unsubscribe from the service (hereinafter also “unsubscribes”). The experiments that impact the particular metric may have a positive impact or a negative impact on the particular metric.

The access module 204 accesses a subscription record in a database. The accessing may be based on the metric identifier of the particular metric. The subscription record may be associated with the particular metric, and may identify one or more users who requested to follow the particular metric. In some example embodiments, a user requests to follow the particular metric by selecting a selectable element (e.g., a button marked “follow,” hereinafter also a “follow button”) of a user interface that is displayed on a client device associate with the user. The client device may transmit a communication to the metrics following system 200 that indicates the selection of the follow button that corresponds to the particular metric. Based on the communication transmitted from the client device, the metrics following system 200 may generate (or update) the subscription record in the database, and may add a user identifier of the user to the subscription record to indicate that a request to follow the particular metric has been received from the client device associated with the user. In some example embodiments, instead or in addition to adding the user identifier to the subscription record, the metrics following system 200 adds a client device identifier of the client device to a subscription record associated with the metric identifier.

The content generation module 206 identifies, based on the subscription record, a user identifier of a user of the one or more users who requested to follow the particular metric. The content generation module 206 also generates a digital content item that references the particular metric and the experiments that impact the particular metric. The content may be generated (e.g., customized) for the user. The generating of the digital content item may be based on the one or more experiment identifiers of experiments that impact the particular metric and based on the user identifier of the user. For example, the experiment identifying module 202 determines that a first metric is impacted by a first experiment and a second experiment. The experiment identifying module 202 also determines that a second metric is impacted by a third experiment. The content generation module 206 identifies a first user identifier of a first user who requested to follow the first metric. The content generation module 206 also determines that the first user requested to follow a second metric based on identifying the first user identifier of the first user in a second subscription record associated with the second metric. The content generation module 206 generates a digital content item that references the first metric and the first and second experiments that impact the first metric, and the second metric and the third experiment that impacts the second metric.

The presentation module 208 causes a presentation of the digital content item in a user interface of a client device associated with the user. In some example embodiments, the presentation of the digital content item in the user interface of the client device is caused in an email message transmitted to an email address associated with the user. In some example embodiments, the user interface of the client device is a dashboard associated with an experimentation system that executes the experiments. The experimentation system may be internal or external to the metrics following system 200.

The experiment execution module 210 executes one or more experiments pertaining to one or more services provided on the SNS. The executing of the one or more experiments generates experiment results.

The metric identifying module 212 identifies one or more metrics including the particular metric that are impacted by the executing of the one or more experiments. The identifying of the one or more metrics is based on the experiment results. The metric identifying module 212 generates an impacted metrics record (or updates an existing impacted metrics record) in a database based on the identifying of the one or more metrics that are impacted by the executing of the one or more experiments. The impacted metrics record may include one or more associations among identifiers of the one or more experiments and identifiers of the one or more metrics that are impacted by the executing of the one or more experiments. The determining of the one or more experiment identifiers of experiments that impact the particular metric may be based on the metric identifier of the particular metric that is included in the impacted metrics record.

In some example embodiments, the metric identifying module 212 identifies, based on the user identifier, one or more other metrics followed by the user. In some instances, the one or more other metrics followed by the user are stored in a database record associated with the user identifier. The digital content item generated by the content generation module 206 includes metric identifiers of a plurality of metrics (e.g., all of the metrics requested to be followed by the user) including the particular metric and the one or more other metrics followed by the user. The metric identifier of each metric of the plurality of metrics is displayed in association with experiment identifiers of the one or more experiments that impact a respective metric in the user interface of the client device.

For example, a first metric is followed by a first user and a second user. A second metric is followed by the first user and a third user. A third metric is followed by the second user and the third user. The presentation module 208 may transmit a first email message to the first user. The first email message may include an identifier of the first metric and a first list of experiments that impact the first metric, and an identifier of the second metric and a second list of experiments that impact the second metric. The presentation module 208 may transmit a second email message to the second user that includes the identifier of the first metric and the first list of experiments that impact the first metric, and an identifier of the third metric and a third list of experiments that impact the third metric. The presentation module 208 may transmit a third email message to the third user that includes the identifier of the second metric and the second list of experiments that impact the second metric, and the identifier of the third metric and the third list of experiments that impact the third metric.

The subscription module 214, in some example embodiments, adds a user identifier (or, in some instances, a client device identifier) to the subscription record that identifies the one or more users who requested to follow the particular metric. In some example embodiments, the presentation module 208 causes a presentation of a further user interface on the client device. In some instances, the causing of the presentation of the further user interface on the client device is based on receiving login data associated with the user from the client device. The further user interface may include one or more selectable elements (e.g., buttons, menus, etc.) pertaining to requesting a following of one or more metrics. The access module 204 may receive a selection of a selectable element of the one or more selectable elements included in the further user interface from the client device. The selection of the selectable element may correspond to a request to follow the particular metric. The subscription module 214 determines, based on the receiving of the selection of the selectable element, that the selectable element corresponds to the particular metric. The subscription module 214 adds the user identifier to the subscription record that identifies the one or more users who requested to follow the particular metric.

The subscription module 214, in some example embodiments, removes the user identifier from the subscription record that identifies the one or more users who requested to follow the particular metric. In some example embodiments, the presentation module 208 causes a presentation of a further user interface on the client device. The further user interface includes one or more selectable elements pertaining to requesting an unfollowing of one or more metrics. The access module 204 may receive a selection of a selectable element of the one or more selectable elements included in the further user interface from the client device. The selection of the selectable element may correspond to a request to unfollow the particular metric. The subscription module 214 determines, based on the receiving of the selection of the selectable element, that the selectable element corresponds to the particular metric. The subscription module 214 removes the user identifier from the subscription record that identifies the one or more users who requested to follow the particular metric.

The type identifying module 216, in some example embodiments, identifies a type of the client device associated with the user. Examples of types of the client device include a smartphone, a tablet, a desktop, a particular brand of client device, a particular model of client device, etc. The content generation module 206 accesses a presentation template associated with the type of the client device. The generating of the digital content item, by the content generation module 206, may include merging the presentation template and data pertaining to the one or more experiment identifiers of experiments that impact the particular metric.

The type identifying module 216, in some example embodiments, identifies a type of browser associated with the client device. Examples of the type of browser include Windows Internet Explorer, Google Chrome, Mozilla Firefox, Apple Safari, etc. The content generation module 206 accesses a presentation template associated with the type of browser associated with the client device. The generating of the digital content item, by the content generation module 206, may include combining the presentation template and data pertaining to the one or more experiment identifiers of experiments that impact the particular metric.

To perform one or more of its functionalities, the metrics following system 200 may communicate with one or more other systems. For example, an integration system may integrate the metrics following system 200 with one or more email server(s), web server(s), one or more databases, or other servers, systems, or repositories.

Any one or more of the modules described herein may be implemented using hardware (e.g., one or more processors of a machine) or a combination of hardware and software. For example, any module described herein may configure a hardware processor (e.g., among one or more hardware processors of a machine) to perform the operations described herein for that module. In some example embodiments, any one or more of the modules described herein may comprise one or more hardware processors and may be configured to perform the operations described herein, In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 218 (e.g., database 128, 130, 132, 136, 138, or 140).

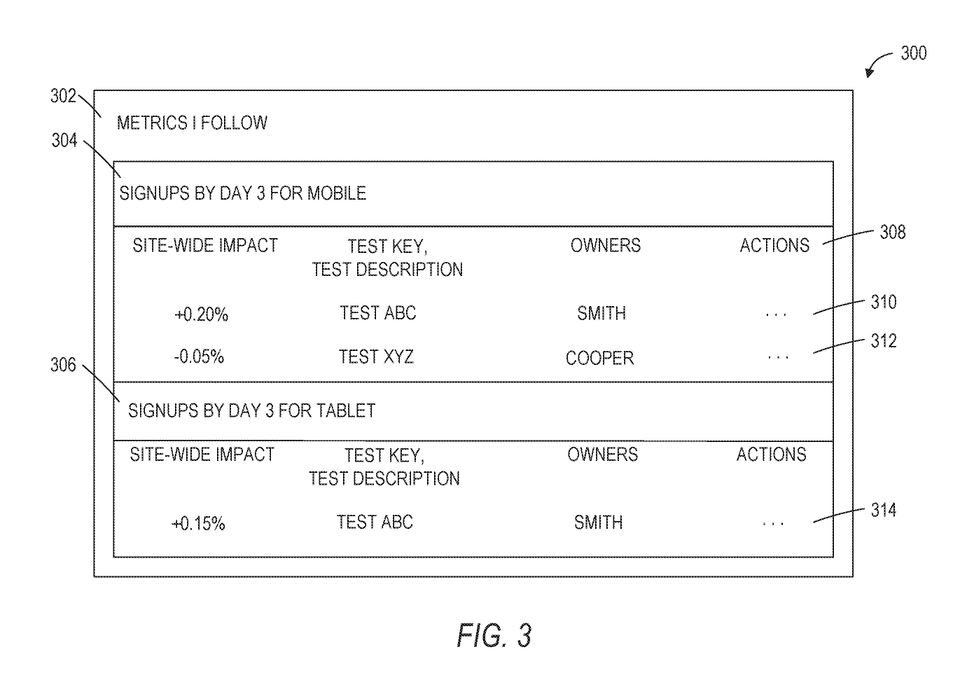

FIG. 3 is a diagram illustrating an example user interface for displaying followed metrics, according to some example embodiments. As shown in FIG. 3, a user interface 300 may present various information pertaining to one or more metrics followed by a user. The user interface 300 may be displayed on a display screen of a client device (e.g., a desktop, a laptop, a smartphone, a tablet, etc.) associated with a user. For example, the user interface 300 displays identifiers of one or more metrics, such as metric name 304 and metric name 306, under the title “Metrics I Follow” 302.

In addition, the user interface 300 may display, for each followed metric, data pertaining to one or more experiments that impact the respective metric. For instance, as shown in FIG. 3, various data pertaining to Test ABC is displayed in line 310 of the user interface 300. Also, various data pertaining to Test XYZ is displayed in line 312 of the user interface 300. Some examples of types of data pertaining to the one or more experiments are identified in line 308 and include a site-wide impact value, a test key (e.g., a name of the test), a test description, identifiers of owners of the test, and actions that may be taken by the metrics follower (e.g., the user).

According to some example embodiments, the site-wide impact of an experiment on a metric is the percentage delta between two scenarios or “parallel universes”: one with the treatment variant of an experiment applied to only targeted users and the control variant of the experiment applied to the rest, the other with the control variant applied to all. Put another way, the site-wide impact value is the x% delta if a treatment variant is ramped to 100% of its targeting segment. With site-wide impact value provided for all experiments, users are able to compare results across experiments regardless of their targeting and triggering conditions. Moreover, the site-wide impact values from multiple segments of the same experiment can be added up to give an assessment of the total impact.

In certain example embodiments, the user interface 300 provides an indication of an absolute site-wide impact value, a percentage site-wide impact value, or both. For example, as illustrated in FIG. 3, the percentage site-wide impact value of Test ABC on metric 304 (e.g., “Signups by day 3 for mobile”) is “+0.20%,” and the percentage site-wide impact value of Test XYZ on metric 304 (e.g., “Signups by day 3 for mobile”) is “−0.05%.”

As shown in line 308 of the user interface 300 of FIG, 3, the experiments that impact a particular metric may be identified by a test identifier (e.g., a test key, a test name, etc.), In some instances, in addition to displaying a test key, the user interface 300 may also display a test description which may provide information regarding the functionality or the purpose of the test. The user interface 300 also displays identifiers of the owners (e.g., names or email addresses of engineers, administrators, etc.) of the impactful experiments, and identifies actions that may be taken by a user viewing metrics followed by the user. An example of such action is drafting an email message for an owner of an experiment to discuss the results of the experiment.

In some example embodiments, various data elements displayed in the user interface 300 are selectable by the user. For example, the metric identifier 304, “Signups by day 3 for mobile” is a selectable element of the user interface 300. The user may select (e.g., click on) the metric identifier 304, “Signups by day 3 for mobile.” Based on receiving, from the client device associated with the user, an indication of the selection of the metric identifier 304, the metrics following system 200 may identify data pertaining to the metric “Signups by day 3 for mobile” in a record of a database. The metrics following system 200 may cause a display of the identify data pertaining to the metric “Signups by day 3 for mobile” in the user interface 300 (e.g., in a window associated with the user interface 300) or in a further user interface.

According to another example, a test identifier (e.g., “Test ABC”) is a. selectable element of the user interface 300. The user may select (e.g., click on) the test identifier “Test ABC.” Based on receiving, from the client device associated with the user, an indication of the selection of the test identifier “Test ABC,” the metrics following system 200 may identify data pertaining to the test identifier “Test ABC” in a record of a database. The metrics following system 200 may cause a display of the identify data pertaining to the test identifier “Test ABC” in the user interface 300 (e.g., in a window associated with the user interface 300) or in a further user interface.

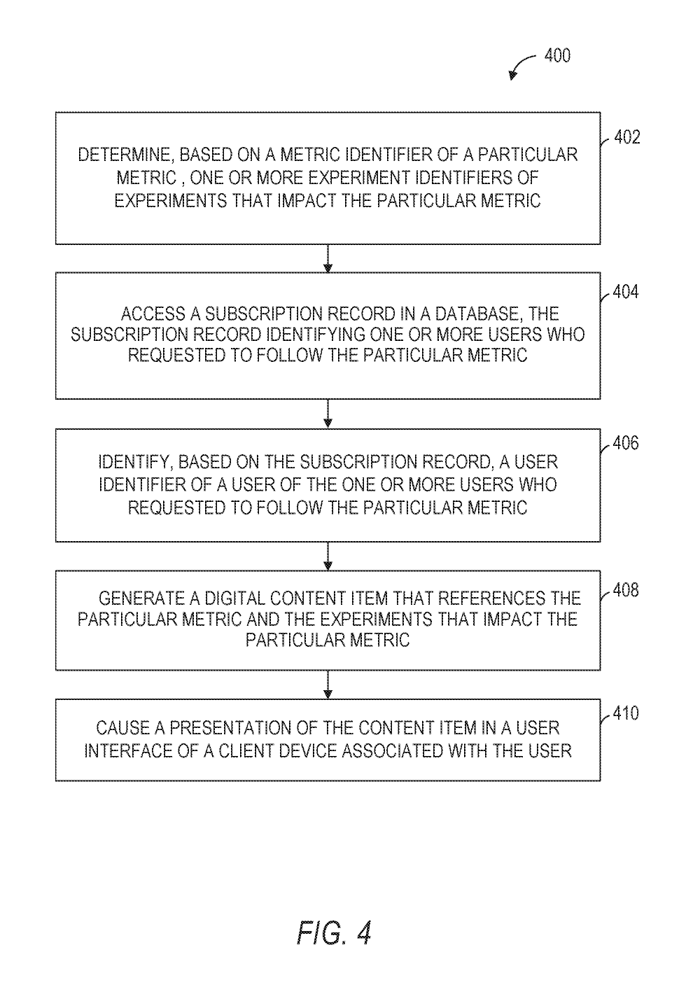

FIGS. 4-8 are flowcharts illustrating a method for facilitating following metrics generated by an A/B testing system, according to some example embodiments. Operations in the method 400 illustrated in FIG. 4 may be performed using modules described above with respect to FIG. 2. As shown in FIG. 4, method 400 may include one or more of method operations 402, 404, 406, 408, and 410, according to some example embodiments.

At operation 402, the experiment identifying module 202 determines one or more experiment identifiers of experiments that impact a particular metric that measures an aspect of a service provided on a Social Networking Service (SNS). The determining of the one or more experiment identifiers of experiments that impact a particular metric may be based on a metric identifier (e.g., a name) of the particular metric.

At operation 404, the access module 204 accesses a subscription record in a database. The accessing may be based on the metric identifier of the particular metric. The subscription record may be associated with the particular metric, and may identify one or more users who requested to follow the particular metric.

At operation 406, the content generation module 206 identifies, based on the subscription record, a user identifier of a user of the one or more users who requested to follow the particular metric.

At operation 408, the content generation module 206 generates a digital content item that references the particular metric and the experiments that impact the particular metric. The content may be generated (e.g., customized) for the user. The generating of the digital content item may be based on the one or more experiment identifiers of experiments that impact the particular metric and based on the user identifier of the user.

For example, the experiment identifying module 202 determines that a first metric is impacted by a first experiment and a second experiment. The experiment identifying module 202 also determines that a second metric is impacted by a third experiment. The content generation module 206 identifies a first user identifier of a first user who requested to follow the first metric. The content generation module 206 also determines that the first user requested to follow the second metric based on identifying the first user identifier of the first user in a second subscription record associated with the second metric. The content generation module 206 generates a digital content item that references the first metric and the first and second experiments that impact the first metric, and the second metric and the third experiment that impacts the second metric.

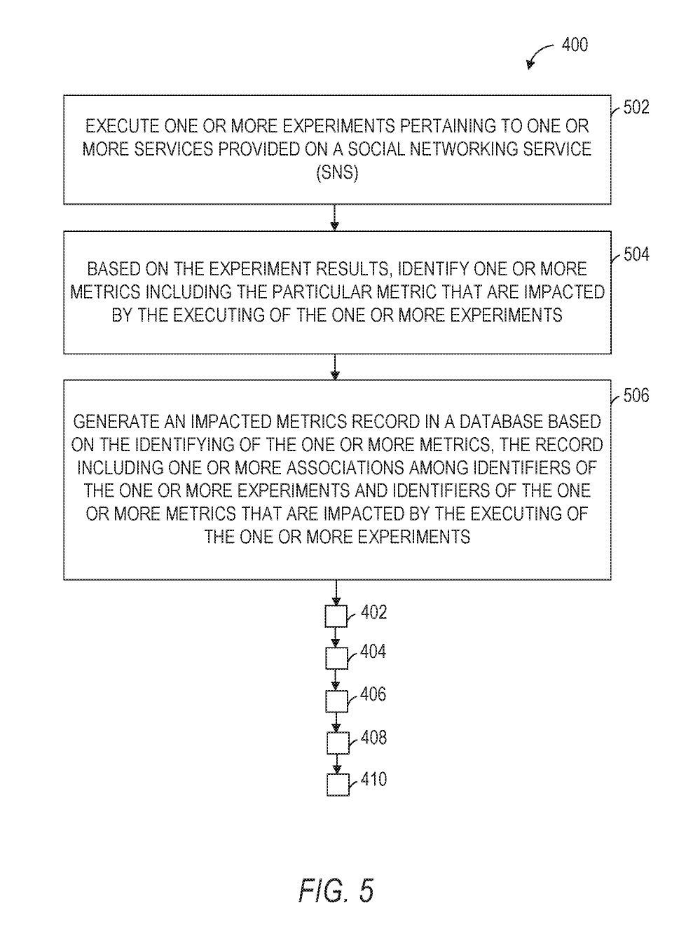

At operation 410, the presentation module 208 causes a presentation of the digital content item in a user interface of a client device associated with the user. Further details with respect to the method operations of the method 400 are described below with respect to FIGS. 5-8.

As shown in FIG. 5, the method 400 may include one or more method operations 502, 504, or 506, according to some example embodiments. Operation 502 may be performed before operation 402 of FIG. 4, in which the experiment identifying module 202 determines the one or more experiment identifiers of the experiments that impact the particular metric that measures an aspect of a service provided on the SNS.

At operation 502, the experiment execution module 210 executes one or more experiments pertaining to one or more services provided on the SNS. The executing of the one or more experiments generates experiment results. The executing of the one or more experiments may include applying one or more variants of an experiment to one or more users. The one or more users may be included in one or more groups (e.g., a treatment group or a control group) of users.

At operation 504, the metric identifying module 212 identifies one or more metrics including the particular metric that are impacted by the executing of the one or more experiments. The identifying of the one or more metrics is based on the experiment results.

At operation 506, the metric identifying module 212 generates an impacted metrics record (or updates an existing impacted metrics record) in a database based on the identifying of the one or more metrics that are impacted by the executing of the one or more experiments. The impacted metrics record may include one or more associations among identifiers of the one or more experiments and identifiers of the one or more metrics that are impacted by the executing of the one or more experiments. The determining of the one or more experiment identifiers of experiments that impact the particular metric may be based on the metric identifier of the particular metric that is included in the impacted metrics record.

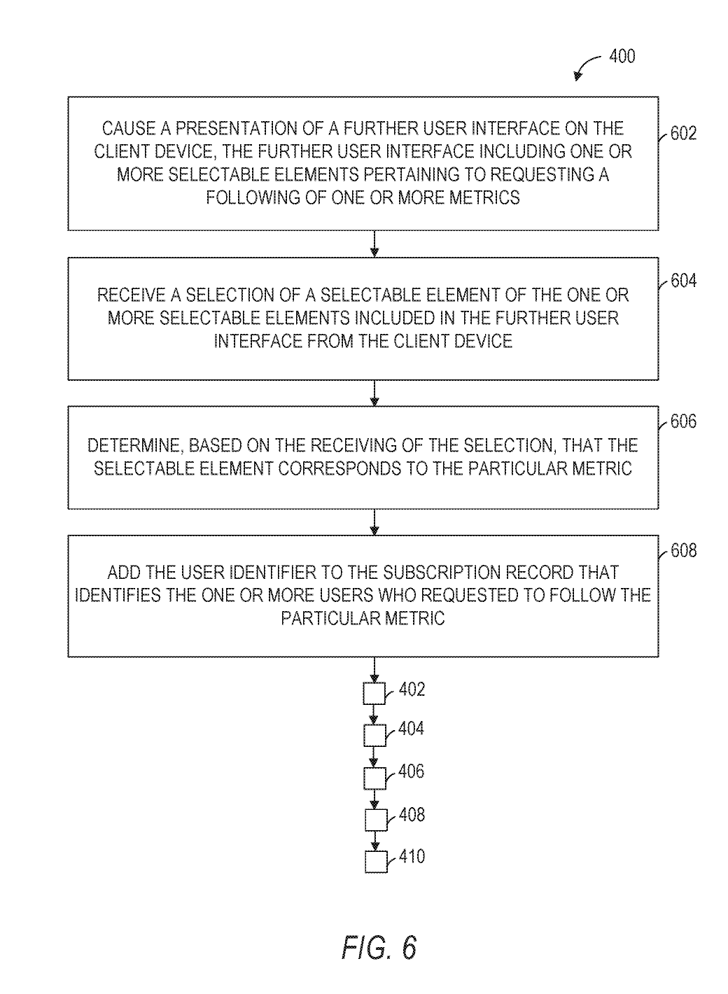

As shown in FIG. 6, the method 400 may include one or more method operations 602, 604, 606, or 608, according to some example embodiments. Operation 602 may be performed before operation 402 of FIG. 4, in which the experiment identifying module 202 determines the one or more experiment identifiers of the experiments that impact the particular metric that measures an aspect of a service provided on the SNS.

At operation 602, the presentation module 208 causes a presentation of a further user interface on the client device. In some instances, the causing of the presentation of the further user interface on the client device is based on receiving login data associated with the user from the client device. The further user interface may include one or more selectable elements (e.g., buttons, menus, etc.) pertaining to requesting a following of one or more metrics.

At operation 604, the access module 204 receives a selection of a selectable element of the one or more selectable elements included in the further user interface from the client device. The selection of the selectable element may correspond to a request to follow the particular metric. The receiving of the selection of a selectable element may include receiving, from the client device, a communication that includes a request to follow the particular metric.

At operation 606, the subscription module 214 determines that the selectable element corresponds to the particular metric. The determining may be based on the receiving of the selection of the selectable element.

At operation 608, the subscription module 214 adds the user identifier to the subscription record that identifies the one or more users who requested to follow the particular metric.

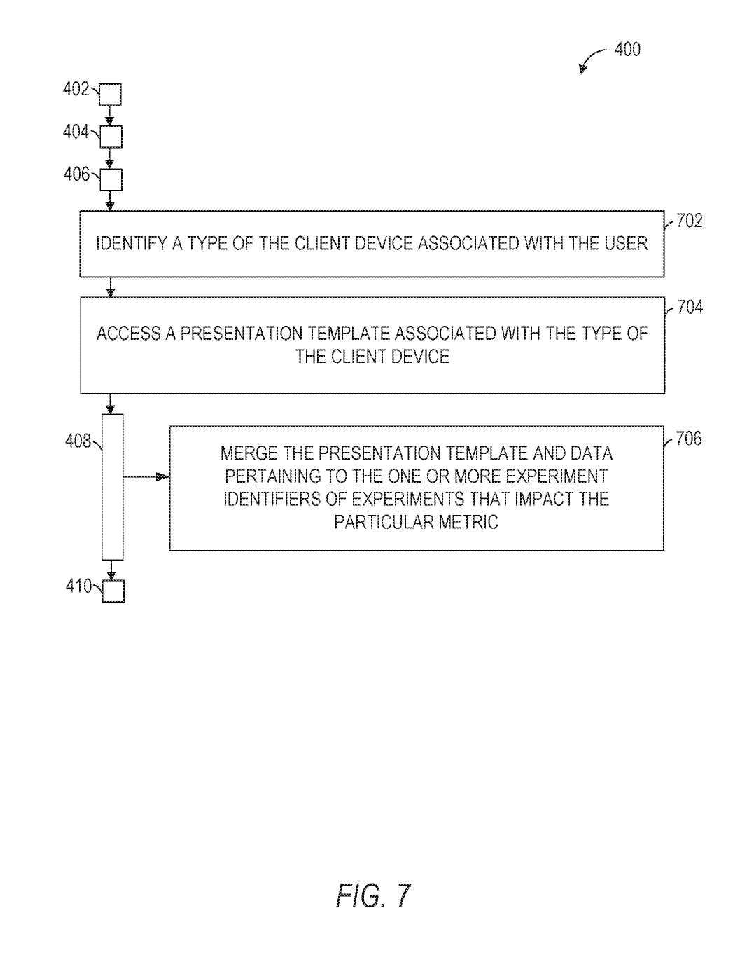

As shown in FIG. 7, the method 400 may include one or more method operations 702, 704, or 706, according to some example embodiments. Operation 702 may be performed after operation 406 of FIG. 4, in which the content generation module 206 identifies, based on the subscription record, a user identifier of a user of the one or more users who requested to follow the particular metric.

At operation 702, the type identifying module 216 identifies a type of the client device associated with the user. Examples of types of the client device include a smartphone, a tablet, a desktop, a particular brand of client device, a particular model of client device, etc. In some instances, the identifying of the type of the client device is based on a request for data received from the client device. The request for data indicates (e.g., references) the type of the client device. In some instances, the identifying of the type of the client device is based on a database record that stores an indication of the type of the client device.

Operation 704 may be performed after operation 702. At operation 704, the content generation module 206 accesses a presentation template associated with the type of the client device. The presentation template may be software code stored in and accessed from a record of a database.

Operation 706 may be performed as part (e.g., a precursor task, a subroutine, or a portion) of operation 408 of FIG. 4, in which the content generation module 206 generates a digital content item that references the particular metric and the experiments that impact the particular metric. The generating of the digital content item, by the content generation module 206, may include merging the presentation template and data pertaining to the one or more experiment identifiers of experiments that impact the particular metric.

According to some example embodiments, the type identifying module 216 identifies a type of browser associated with the client device. Examples of the type of browser include Windows Internet Explorer, Google Chrome, Mozilla Firefox, Apple Safari, etc. In some instances, the identifying of the type of the browser is based on a request for data received from the client device. The request for data indicates references) the type of the browser associated with the client device. In some instances, the identifying of the type of the browser is based on a database record that stores an indication of the type of the browser. The content generation module 206 accesses a presentation template associated with the type of browser associated with the client device. The generating of the digital content item, by the content generation module 206, may include combining the presentation template and data pertaining to the one or more experiment identifiers of experiments that impact the particular metric.

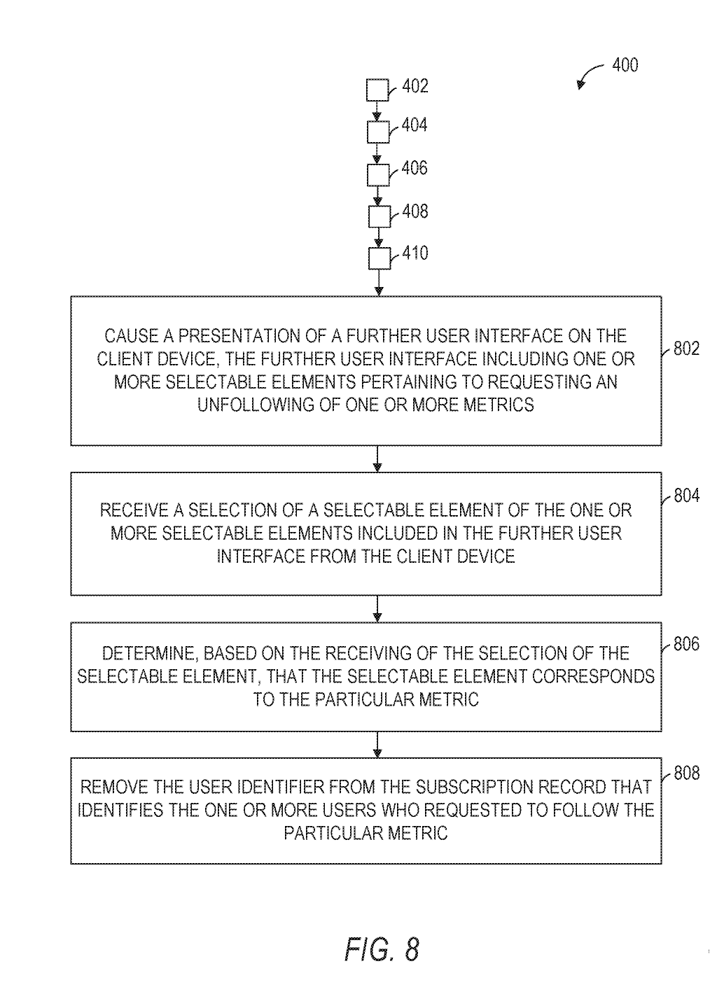

As shown in FIG. 8, the method 400 may include one or more method operations 802, 804, 806, or 808, according to some example embodiments. Operation 802 may be performed after operation 410 of FIG. 4, in which the presentation module 208 causes a presentation of the digital content item in a user interface of a client device associated with the user.

At operation 802, the presentation module 208 causes a presentation of a further user interface on the client device. The further user interface includes one or more selectable elements pertaining to requesting an unfollowing of one or more metrics.

At operation 804, the access module 204 receives a selection of a selectable element of the one or more selectable elements included in the further user interface from the client device. The selection of the selectable element may correspond to a request to unfollow the particular metric.

At operation 806, the subscription module 214 determines that the selectable element corresponds to the particular metric. The determining may be based on the receiving of the selection of the selectable element.

At operation 808, the subscription module 214 removes the user identifier from the subscription record that identifies the one or more users who requested to follow the particular metric.

### Example Mobile Device

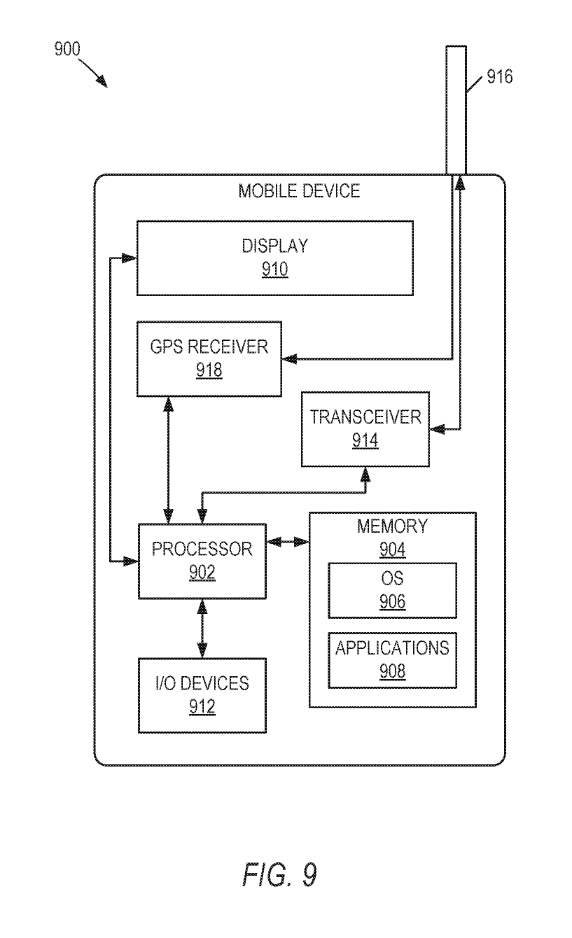

FIG. 9 is a block diagram illustrating a mobile device 900, according to an example embodiment. The mobile device 900 may include a processor 902. The processor 902. may be any of a variety of different types of commercially available processors 902 suitable for mobile devices 900 (for example, an XScale architecture microprocessor, a microprocessor without interlocked pipeline stages (MIPS) architecture processor, or another type of processor 902). A memory 904, such as a random access memory (RAM), a flash memory, or other type of memory, is typically accessible to the processor 902. The memory 904 may be adapted to store an operating system (OS) 906, as well as application programs 908, such as a mobile location enabled application that may provide LBSs to a user. The processor 902 may be coupled, either directly or via appropriate intermediary hardware, to a display 910 and to one or more input/output (i/O) devices 912, such as a keypad, a touch panel sensor, a microphone, and the like. Similarly, in some embodiments, the processor 902 may be coupled to a transceiver 914 that interfaces with an antenna 916. The transceiver 914 may be configured to both transmit and receive cellular network signals, wireless data signals, or other types of signals via the antenna 916, depending on the nature of the mobile device 900. Further, in some configurations, a GPS receiver 918 may also make use of the antenna 916 to receive GPS signals.

### Modules, Components and Logic

Certain embodiments are described herein as including logic or a number of components, modules, or mechanisms. Modules may constitute either software modules code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

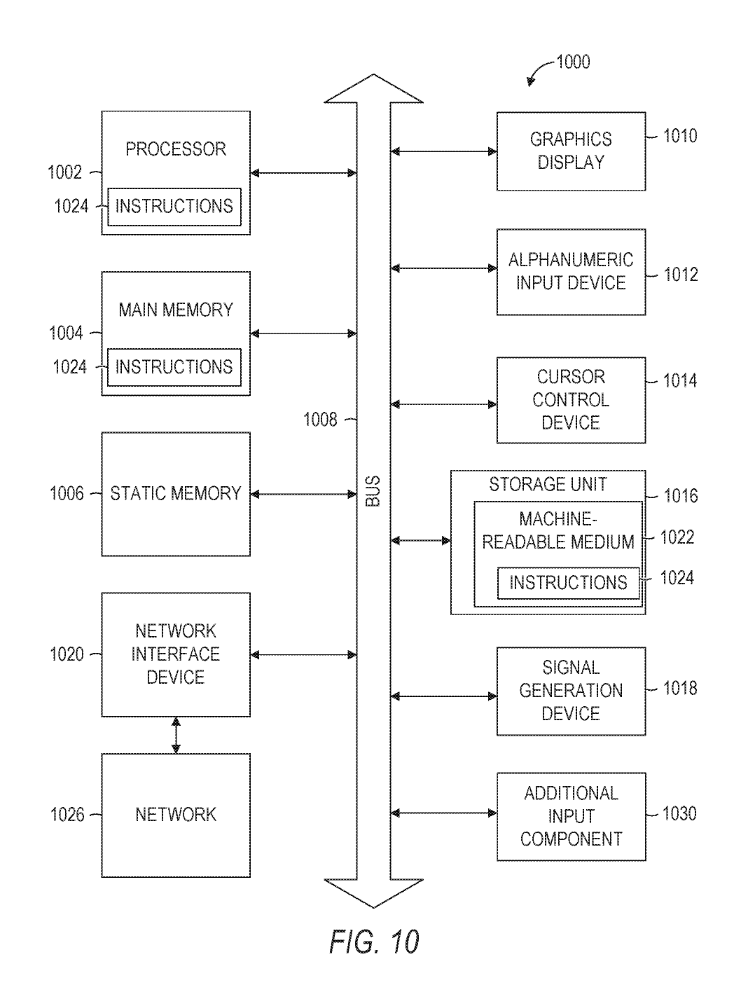

FIG. 10 is a block diagram illustrating components of a machine 1000, according to some example embodiments, able to read instructions 1024 from a machine-readable medium 1022 (e.g., a non-transitory machine-readable medium, a machine-readable storage medium, a computer-readable storage medium, or any suitable combination thereof) and perform any one or more of the methodologies discussed herein, in whole or in part. Specifically, FIG. 10 shows the machine 1000 in the example form of a computer system (e.g., a computer) within which the instructions 1024 (e.g., software, a program, an application, an applet, an app, or other executable code) for causing the machine 1000 to perform any one or more of the methodologies discussed herein may be executed, in whole or in part.

In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The processor 1002 may contain microcircuits that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e.g., software modules) described herein.

The machine 1000 may further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, an audio generation device 1018 (e.g., a sound card, an amplifier, a speaker, a headphone jack, or any suitable combination thereof), and a network interface device 1020.

The storage unit 1016 includes the machine-readable medium 1022 (e.g., a tangible and non-transitory machine-readable storage medium) on which are stored the instructions 1024 embodying any one or more of the methodologies or functions described herein. The instructions 1024 may also reside, completely or at least partially, within the main memory 1004, within the processor 1002 (e.g., within the processor's cache memory), or both, before or during execution thereof by the machine 1000. Accordingly, the main memory 1004 and the processor 1002 may be considered machine-readable media (e.g., tangible and non-transitory machine-readable media). The instructions 1024 may be transmitted or received over the network 1026 via the network interface device 1020. For example, the network interface device 1020 may communicate the instructions 1024 using any one or more transfer protocols (e.g., hypertext transfer protocol (HTTP)).

In some example embodiments, the machine 1000 may be a portable computing device, such as a smart phone or tablet computer, and have one or more additional input components 1030 (e.g., sensors or gauges). Examples of such input components 1030 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
determining, based on a metric identifier of a particular metric that measures an aspect of a service provided on a Social Networking Service (SNS), one or more experiment identifiers of experiments that impact the particular metric;
accessing, based on the metric identifier of the particular metric, a subscription record in a database, the subscription record identifying one or more users who requested to follow the particular metric;
identifying, based on the subscription record, a user identifier of a user of the one or more users who requested to follow the particular metric;
generating, using one or more hardware processors, a digital content item that references the particular metric and the experiments that impact the particular metric, the generating of the digital content item being based on the one or more experiment identifiers of experiments that impact the particular metric and based on the user identifier of the user; and
causing a presentation of the digital content item in a user interface of a client device associated with the user.

2. The method of claim 1, further comprising:
executing one or more experiments pertaining to one or more services provided on the SNS, the executing of the one or more experiments generating experiment results;
based on the experiment results, identifying one or more metrics including the particular metric that are impacted by the executing of the one or more experiments; and
generating an impacted metrics record in a database based on the identifying of the one or more metrics, the impacted metrics record including one or more associations among identifiers of the one or more experiments and identifiers of the one or more metrics that are impacted by the executing of the one or more experiments,
wherein the determining of the one or more experiment identifiers of experiments that impact the particular metric is based on the metric identifier of the particular metric that is included in the impacted metrics record.

3. The method of claim 1, further comprising:
causing a presentation of a further user interface on the client device, the further user interface including one or more selectable elements pertaining to requesting a following of one or more metrics;
receiving a selection of a selectable element of the one or more selectable elements included in the further user interface from the client device, the selection of the selectable element corresponding to a request to follow the particular metric;
determining, based on the receiving of the selection of the selectable element, that the selectable element corresponds to the particular metric; and
adding the user identifier to the subscription record that identifies the one or more users who requested to follow the particular metric.

4. The method of claim 1, further comprising:
identifying a type of the client device associated with the user; and
accessing a presentation template associated with the type of the client device,
wherein the generating of the digital content item includes merging the presentation template and data pertaining to the one or more experiment identifiers of experiments that impact the particular metric.

5. The method of claim 1, further comprising:
identifying a type of browser associated with the client device; and
accessing a presentation template associated with the type of browser associated with the client device,
wherein the generating of the digital content item includes combining the presentation template and data pertaining to the one or more experiment identifiers of experiments that impact the particular metric.

6. The method of claim 1, further comprising:
based on the user identifier, identifying one or more other metrics followed by the user,
wherein the digital content item includes metric identifiers of a plurality of metrics including the particular metric and the one or more other metrics followed by the user, and
wherein the metric identifier of each metric of the plurality of metrics is displayed in association with experiment identifiers of the one or more experiments that impact a respective metric in the user interface of the client device.

7. The method of claim 1, wherein the presentation of the digital content item in the user interface of the client device is caused in an email message transmitted to an email address associated with the user.

8. The method of claim 1, wherein the user interface of the client device is a dashboard associated with an experimentation system that executes the experiments.

9. The method of claim 1, further comprising:
causing a presentation of a further user interface on the client device, the further user interface including one or more selectable elements pertaining to requesting an unfollowing of one or more metrics;
receiving a selection of a selectable element of the one or more selectable elements included in the further user interface from the client device, the selection of the selectable element corresponding to a request to unfollow the particular metric;
determining, based on the receiving of the selection of the selectable element, that the selectable element corresponds to the particular metric; and
removing the user identifier from the subscription record that identifies the one or more users who requested to follow the particular metric.

10. A system comprising:
one or more hardware processors; and
a machine-readable medium for storing instructions that, when executed by the one or more hardware processors, cause the one or more hardware processors to perform operations comprising:
determining, based on a metric identifier of a particular metric that measures an aspect of a service provided on a Social Networking Service (SNS), one or more experiment identifiers of experiments that impact the particular metric;
accessing, based on the metric identifier of the particular metric, a subscription record in a database, the subscription record identifying one or more users who requested to follow the particular metric;
identifying, based on the subscription record, a user identifier of a user of the one or more users who requested to follow the particular metric;
generating a digital content item that references the particular metric and the experiments that impact the particular metric, the generating of the digital content item being based on the one or more experiment identifiers of experiments that impact the particular metric and based on the user identifier of the user; and
causing a presentation of the digital content item in a user interface of a client device associated with the user.

11. The system of claim 10, wherein the operations further comprise:
executing one or more experiments pertaining to one or more services provided on the SNS, the executing of the one or more experiments generating experiment results;
based on the experiment results, identifying one or more metrics including the particular metric that are impacted by the executing of the one or more experiments; and
generating an impacted metrics record in a database based on the identifying of the one or more metrics, the impacted metrics record including one or more associations among identifiers of the one or more experiments and identifiers of the one or more metrics that are impacted by the executing of the one or more experiments,
wherein the determining of the one or more experiment identifiers of experiments that impact the particular metric is based on the metric identifier of the particular metric that is included in the impacted metrics record.

12. The system of claim 10, wherein the operations further comprise:
causing a presentation of a further user interface on the client device, the further user interface including one or more selectable elements pertaining to requesting a following of one or more metrics;
receiving a selection of a selectable element of the one or more selectable elements included in the further user interface from the client device, the selection of the selectable element corresponding to a request to follow the particular metric;
determining, based on the receiving of the selection of the selectable element, that the selectable element corresponds to the particular metric; and
adding the user identifier to the subscription record that identifies the one or more users who requested to follow the particular metric.

13. The system of claim 10, wherein the operations further comprise:
identifying a type of the client device associated with the user; and
accessing a presentation template associated with the type of the client device,
wherein the generating of the digital content item includes merging the presentation template and data pertaining to the one or more experiment identifiers of experiments that impact the particular metric.

14. The system of claim 10, wherein the operations further comprise:
identifying a type of browser associated with the client device; and
accessing a presentation template associated with the type of browser associated with the client device,
wherein the generating of the digital content item includes combining the presentation template and data pertaining to the one or more experiment identifiers of experiments that impact the particular metric.

15. The system of claim 10, wherein the operations further comprise:
based on the user identifier, identifying one or more other metrics followed by the user,
wherein the digital content item includes metric identifiers of a plurality of metrics including the particular metric and the one or more other metrics followed by the user, and
wherein the metric identifier of each metric of the plurality of metrics is displayed in association with experiment identifiers of the one or more experiments that impact a respective metric in the user interface of the client device.

16. The system of claim 10, wherein the presentation of the digital content item in the user interface of the client device is caused in an email message transmitted to an email address associated with the user.

17. The system of claim 10, wherein the user interface of the client device is a dashboard associated with an experimentation system that executes the experiments.

18. The system of claim 10, wherein the operations further comprise:
causing a presentation of a further user interface on the client device, the further user interface including one or more selectable elements pertaining to requesting an unfollowing of one or more metrics;
receiving a selection of a selectable element of the one or more selectable elements included in the further user interface from the client device, the selection of the selectable element corresponding to a request to unfollow the particular metric;
determining, based on the receiving of the selection of the selectable element, that the selectable element corresponds to the particular metric; and
removing the user identifier from the subscription record that identifies the one or more users who requested to follow the particular metric.

19. A non-transitory machine-readable medium for storing instructions that when executed by one or more hardware processors of a machine, cause the one or more hardware processors to perform operations comprising:
determining, based on a metric identifier of a particular metric that measures an aspect of a service provided on a Social Networking Service (SNS), one or more experiment identifiers of experiments that impact the particular metric;
accessing, based on the metric identifier of the particular metric, a subscription record in a database, the subscription record identifying one or more users who requested to follow the particular metric;
identifying, based on the subscription record, a user identifier of a user of the one or more users who requested to follow the particular metric;
generating a digital content item that references the particular metric and the experiments that impact the particular metric, the generating of the digital content item being based on the one or more experiment identifiers of experiments that impact the particular metric and based on the user identifier of the user; and
causing a presentation of the digital content item in a user interface of a client device associated with the user.

20. The non-transitory machine-readable medium of claim 19, wherein the operations further comprise:
executing one or more experiments pertaining to one or more services provided on the SNS, the executing of the one or more experiments generating experiment results;
based on the experiment results, identifying one or more metrics including the particular metric that are impacted by the executing of the one or more experiments; and
generating an impacted metrics record in a database based on the identifying of the one or more metrics, the impacted metrics record including one or more associations among identifiers of the one or more experiments and identifiers of the one or more metrics that are impacted by the executing of the one or more experiments,
wherein the determining of the one or more experiment identifiers of experiments that impact the particular metric is based on the metric identifier of the particular metric that is included in the impacted metrics record.
